(19) United States
(12) Patent Application Publication
(10) Pub. No.: US 2010/0250954 A1
(43) Pub. Date: Sep. 30, 2010

(54) WEBSITE LOGIN PROCESSING METHOD AND APPARATUS

(75) Inventors: Daeseon Choi, Daejeon (KR); Seunghyun Kim, Daejeon (KR); Soohyung Kim, Daejeon (KR); Jonghyouk Noh, Daejeon (KR); Sangrae Cho, Daejeon (KR); Youngseob Cho, Daejeon (KR); Seunghun Jin, Daejeon (KR)

Correspondence Address: AMPACC Law Group, 3500 188th Street S.W., Suite 103, Lynnwood, WA, 98037, US

(73) Assignee: Electronics and Telecommunications research, Daejeon (KR)

(21) Appl. No.: 12/743,279

(22) PCT Filed: Sep. 3, 2008
(86) PCT No.: PCT/KR08/05171

§ 371 Date: May 17, 2010

(30) Foreign Application Priority Data
Nov. 20, 2007 (KR) 10-2007-0118449

(51) Int. Cl. G06F 21/20; G06F 17/00

(52) U.S. Cl. 713/182; 726/5

(57) ABSTRACT

Disclosed is a website login processing method and apparatus. If a user tries to log in a website, a plurality of user information that are stored in a user computer are visually displayed to the user, such that the user selects one of the plurality of user information. A login process on the corresponding website is performed on the basis of an ID and a password selected by the user. An encryption key for the user information is generated using random numbers, and the login is validated using the encryption key. The user refers to the user information stored in the user computer and recognizes a list of websites that the user subscribes.

### TECHNICAL FIELD

The present invention relates to a website login processing method and system, and more particularly, to a website login processing method and system that is capable of logging in a website without repeatedly inputting an ID and password of a user.

This work was supported by the IT R&D program of MIC/IITA [2007-S-601-01, User Control Enhanced Digital Identity Wallet System].

### BACKGROUND ART

In general, in order for a user to log in an Internet website, the user needs to input an ID and a password previously registered in the corresponding website. However, it is difficult for the user to memorize an ID and a password of each website, and the user should input an ID and a password whenever the user logs in that website. Therefore, it is inconvenient for the user to log in the website each time.

In order to get rid of inconvenience, two technologies are suggested in the related art. According to a first technology in the related art, if a user logs in a first website, the first website generates a message that confirms an authentication fact and transmits the message to a second website that the user logs in, after the first website. The second website performs a login process on the basis of the authentication confirmation message transmitted from the first website, instead of an ID and a password input by the user.

According to a second technology in the related art, after an ID and a password of each website are stored in advance in a user computer, when a user accesses a website, an ID and a password of the corresponding website that are stored in advance are automatically input.

### DISCLOSURE OF INVENTION

### Technical Problem

However, according to the first technology in the related art, in order for a user to log in the first website again, the user still needs to input an ID and a password of the first website again, resulting in being inconvenient to the user. According to the second technology in the related art, there is a technical limitation in that, when a user accesses a website having two or more IDs, it is not possible to automatically determine which ID is used for logging in the corresponding website.

An object of the present invention is to get rid of inconvenience that a user feels when the user memorizes an ID and a password of a website and inputs the ID and password, in the case of logging in the website.

Another object of the present invention is to allow a user to select any one of a plurality of IDs for websites at the time of logging in a website, thereby getting rid of inconvenience that a user feels when memorizing an ID and a password of each website and inputting the ID and password.

Still another object of the present invention is to generate an encryption key for user information, such as an ID and a password, using random numbers, so as to prevent a password-guessing attack, a dictionary attack, or the like, thereby improving security.

A further object of the present invention is to store user information on websites, such as IDs and passwords, in a user ID management system, thereby allowing a user to easily recognize a list of websites that the user subscribes.

### Technical Solution

In order to achieve the above-described objects, according to a first aspect of the present invention, there is provided a website login processing method that performs a login process in a computer in which website information and one or more user information needed when logging in a website are associated with each other and stored. The website login processing method includes (a) a step of receiving a login command on a specific website from a user; and (b) a step of, in response to the login command, performing a login process on the specific website on the basis of user information, which is selected by the user among a plurality of user information associated with the specific website and stored in the computer.

At this time, the step (b) according to the first aspect of the present invention may include (b1) a step of displaying the plurality of user information associated with the specific website and stored in the computer; and (b2) a step of performing a login process on the specific website on the basis of the user information selected by the user among the plurality of displayed user information.

Further, the step (b) according to the first aspect of the present invention may be performing a login process on the specific website on the basis of user information selected by the user as a default in advance, among the plurality of user information associated with the specific website and stored in the computer.

Meanwhile, the computer according to the first aspect of the present invention may further store an encryption key for the user information that is generated using random numbers, and the step (b) may include validating the login using the encryption key.

Further, in order to achieve the above-described objects, according to a second aspect of the present invention, there is provided a website login processing method. The website login processing method includes (a) a step of providing a computer program, which allows the above website login processing method to be executed, to the computer; and (b) a step of, when the computer executes the computer program, communicating with the computer to execute the login process.

At this time, the step (b) according to the second aspect of the present invention may include (b1) a step of receiving the user information, which is needed when logging in the specific website, from the computer and storing the user information; (b2) a step of receiving a login request for the specific website from the computer; and (b3) a step of comparing user information included in the received login request with the user information stored in the step (b1) to validate the login.

Meanwhile, the step (b) according to the second aspect of the present invention may include (b1) a step of receiving an encryption key, which is generated using random numbers with respect to the user information that is needed when logging in the specific website, from the computer and storing the user information; (b2) a step of receiving a login request for the specific website from the computer; and (b3) a step of comparing an encryption key included in the received login request with the encryption key stored in the step (b1) to validate the login.

Furthermore, in order to achieve the above-described objects, according to a third aspect of the present invention, a website login processing apparatus includes an information storing unit that stores a computer program to allow the above-described website login processing method to be executed; an information processing unit that provides the computer program to the computer, and, when the computer executes the computer program, communicates with the computer to perform the login process; and a web page providing unit that provides a web page of the specific website to the computer in accordance with a result of the login process by the information processing unit.

### ADVANTAGEOUS EFFECTS

According to the present invention, it is possible to get rid of inconvenience that a user feels when the user memorizes an ID and a password of a website and inputs the ID and password, in the case of logging in the website.

According to the present invention, since a user can select any one of a plurality of IDs for websites at the time of logging in a website, it is possible to get rid of inconvenience that a user feels when memorizing an ID and a password of each website and inputting the ID and password.

According to the present invention, since an encryption key for user information, such as an ID and a password, is generated using random numbers, it is possible to prevent a password-guessing attack, a dictionary attack, or the like, thereby improving security.

According to the present invention, since user information on websites, such as IDs and passwords, is stored in a user ID management system, a user can easily recognize a list of websites that the user subscribes.

### BRIEF DESCRIPTION OF THE DRAWINGS

FIG. 1 is a diagram illustrating a structure of a website login processing system according to an embodiment of the present invention.

FIG. 2 is a diagram illustrating a structure of a database that includes website information and user information.

FIG. 3 is an exemplary view illustrating a site card according to an embodiment of the present invention.

FIG. 4 is a flowchart illustrating a website subscribing method according to an embodiment of the present invention.

FIG. 5 is a flowchart illustrating a website login processing method according to an embodiment of the present invention.

FIG. 6 is an exemplary diagram illustrating a detailed structure of systems according to an embodiment of the present invention that are coupled to each other.

FIG. 7 is an exemplary diagram illustrating an inner structure of systems according to an embodiment of the present invention.

### BEST MODE FOR CARRYING OUT THE INVENTION

Hereinafter, an exemplary embodiment of the present invention will be described in detail with reference to the accompanying drawings.

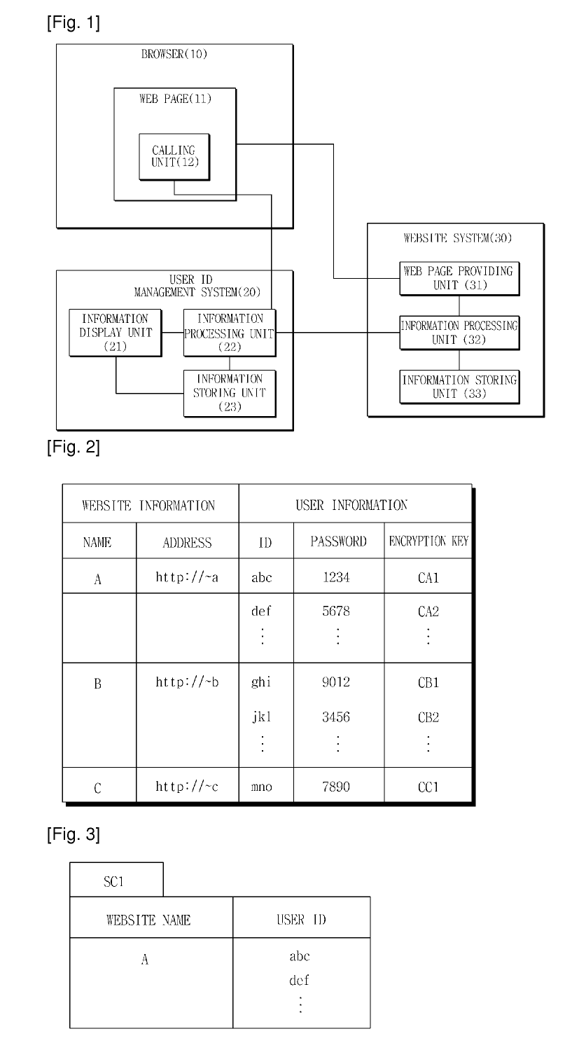

FIG. 1 shows a website login processing system according to an embodiment of the present invention. A website login processing system according to this embodiment includes a user ID management system 20 and a website system 30. The user ID management system 20 includes an information display unit 21, an information processing unit 22, and an information storing unit 23. The website system 30 includes a web page providing unit 31, an information processing unit 32, and an information storing unit 33. The user ID management system 20 and the website system 30 are an example of a website login apparatus according to the embodiment of the present invention.

A browser 10 is an application program that enables a user to view all information on the World Wide Web. The browser 10 calls the information processing unit 22 through a calling unit 12, receives web pages from the web page providing unit 31 of the website system 30, and shows the web pages to the user.

1. Structure of User ID Management System 20

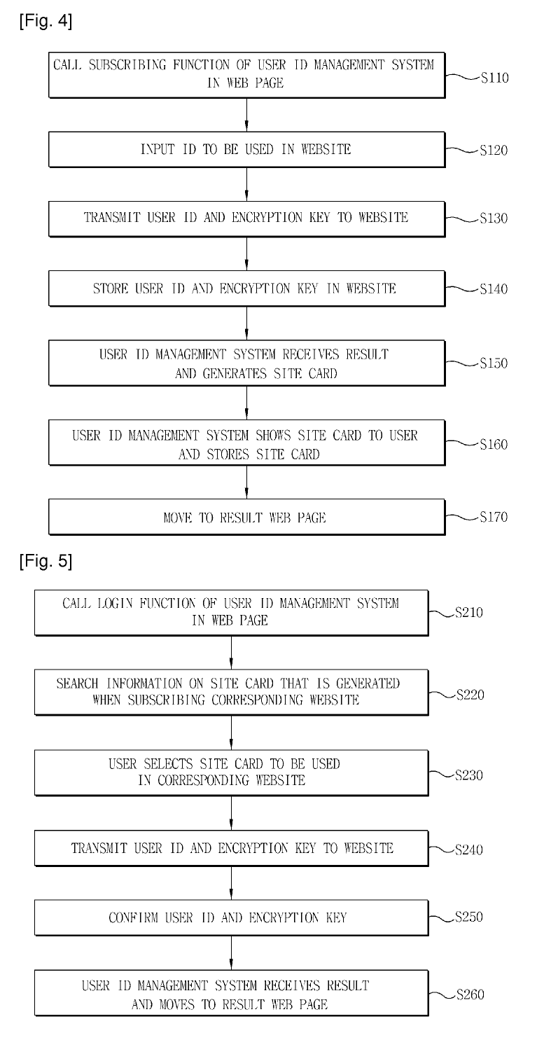

The information storing unit 23 stores a computer program that allows a website subscribing method (refer to FIG. 4) and a website login method (refer to FIG. 5) according to this embodiment to be executed. The computer program may be provided from the website system 30 and executed in the user ID management system 20. The website system 30 may execute the computer program and the execution result may be output to the user ID management system 20.

The information storing unit 23 further stores website information and user information that is needed when logging in a corresponding website. The website information may include information, such as a website name and a website access address. The user information may include information, such as a user ID and a user password. The information storing unit 23 further stores an encryption key for the user information (for example, user ID). The encryption key is generated using random numbers.

As for the user information, a plurality of user information may be stored for the same website. For example, as shown in FIG. 2, for each of websites A and B, a plurality of user information are associated with each website and stored in the information storing unit 23, and for a website C, one user information is associated to the website and stored therein.

The information storing unit 23 may further store information on site cards to be shown to a user through a screen when the user accesses websites. For example, as shown in FIG. 3, the information storing unit 23 stores a site card SC1 for the website A. The information storing unit 23 stores site cards for the other websites in the same method. Alternatively, one site card may be stored for each ID.

The information display unit 21 visually displays a site card for a website that a user accesses. When one site card is assigned to each ID, the information display unit 21 displays site cards for all IDs that are registered in a corresponding website. As shown in FIG. 3, when one site card is assigned to all IDs for a website, the information display unit 21 displays one site card.

The information processing unit 22 performs a data communication with the information processing unit 32 of the website system 30 and performs a website subscribing process and a website login process according to this embodiment.

Further, the information processing unit 22 performs a process of storing website information, user information, encryption key information, and site card information in the information storing unit 23. The information processing unit 22 shows a site card for a website that a user accesses to the user through the information display unit 21, such that the user can select user information that is needed when logging in the website. The information processing unit 22 exchanges a variety of information with the website system 30 so as to perform a login process on the corresponding website on the basis of the user information selected by the user. The information processing unit 22 receives information on a website access address from the website system 30 or transmits information stored in the information storing unit 23 to the website system 30.

2. Structure of Website System 30

The information storing unit 33 stores user information and encryption key information transmitted from the user ID management system 20. The information storing unit 33 further stores a computer program that allows a website subscribing method (refer to FIG. 4) and a website login method (refer to FIG. 5) according to this embodiment to be executed. This computer program may be executed at the request of a user, and the execution result may be provided to the user ID management system 20. Alternatively, the computer program may be provided to the user ID management system 20 to be executed in the user ID management system 20.

The website system 30 cooperates with the user ID management system 20 in response to the execution of the computer program, and performs a website subscribing process and a website login process according to this embodiment.

The web page providing unit 31 provides a web page 11 upon the request from the information processing unit 22 of the user ID management system 20.

The information processing unit 32 performs a data communication with the information processing unit 22 of the user ID management system 20 and performs a website subscribing process and a website login process according to this embodiment. The information processing unit 32 performs a process of providing a web page through the web page providing unit 31. The information processing unit 32 transmits an access address of the corresponding website to the user ID management system 20 upon the request from the user ID management system 20, and stores user information and encryption key information transmitted from the user ID management system 20 in the information storing unit 33.

3. Website Subscribing Method

A website subscribing method will be described with reference to FIG. 4. If a user clicks a “subscription” button in the web page 11 of the website that the user accesses through the browser 10, the browser 10 calls the information processing unit 22 of the user ID management system 20 through the calling unit 12 to allow a subscription function to be executed (S110). At this time, the information processing unit 32 of the website system 30 transmits an access address of the corresponding website to the information processing unit 22 of the user ID management system 20. The information processing unit 22 stores the access address and a name of the corresponding website in the information storing unit 23. This process can be implemented by a web page calling function, such as Java Web Start, Microsoft ActiveX, or Microsoft Smart Client.

The information processing unit 22 requests a user to input user information, such as user ID and password, through the information display unit 21. If the user inputs the user information, the information processing unit 22 acquires the user information input by the user (S120).

The information processing unit 22 generates an encryption key composed of random numbers with respect to the user information, and transmits a subscription request message including the user information and the generated encryption key to the website access address acquired in Step S110 (S130).

The information processing unit 32 of the website system 30 generates a user record including the user information and the encryption key transmitted in Step S130 and stores the user record in the information storing unit 33, and transmits a result message to the information processing unit 22 (S140).

After receiving the result message, the information processing unit 22 of the user ID management system 20 generates a site card including a website name and user information (for example, user ID) (S150). One site card may be generated for each ID. When there is a site card that is already registered in the corresponding website, a new ID may be added to the site card, thereby generating the site card shown in FIG. 3.

The information processing unit 22 shows a user the site card generated in Step S150 and stores the site card in the information storing unit 23 (S160).

The information processing unit 22 returns to the browser 10. The browser 10 outputs a subscription result page included in the web page 11 to a screen (S170).

4. Website Login Processing Method

A website login processing method will be described with reference to FIG. 5. If a user clicks a “login” button in a web page 11 of a website that the user accesses through the browser 10, the browser 10 calls the information processing unit 22 of the user ID management system 20 through the calling unit 12, and starts a login process (S210). At this time, the information processing unit 32 of the website system 30 transmits an access address of the corresponding website to the information processing unit 22 of the user ID management system 20.

The information processing unit 22 searches a site card generated at the time of subscribing the corresponding website from the information storing unit 23 and acquires the site card (S220). When one site card is assigned to each ID, the information processing unit searches site cards for IDs registered in the corresponding website. As shown in FIG. 3, when the IDs are integrated and managed in one site card, the information processing unit 22 searches one site card.

The information processing unit 22 shows a user the site cards acquired in Step S220 through the information display unit 21, such that the user can select one of the site cards (S230). As shown in FIG. 3, when IDs are integrated and managed in one site card, the information processing unit 22 shows the user the site card acquired in Step S220 through the information display unit 21, such that the user can select one of the IDs displayed in the site card. At this time, when user information (for example, user ID) related to the corresponding website is one, Step S230 may be omitted. Also, when a user sets one user information, which is to be used for logging in the corresponding website among a plurality of user information, as a default in advance, Step S230 may be omitted.

The information processing unit 22 transmits a login request message, which includes user information selected or set as a default and an encryption key related to the user information, to an access address of the corresponding website (S240).

The information processing unit 32 of the website system 30 searches a user record, which is matched to the user information and the encryption key transmitted from the information processing unit 22 of the user ID management system 20, from the information storing unit 33 and acquires the user record. Then, if an encryption key included in the user record is matched to the transmitted encryption key, the information processing unit 32 determines that login is successful, and generates a session through the web page providing unit 31 (S250).

The information processing unit 22 returns to the browser 10. The browser 10 outputs a login result page included in the web page 11 to a screen (S260).

5. Website Login Processing System

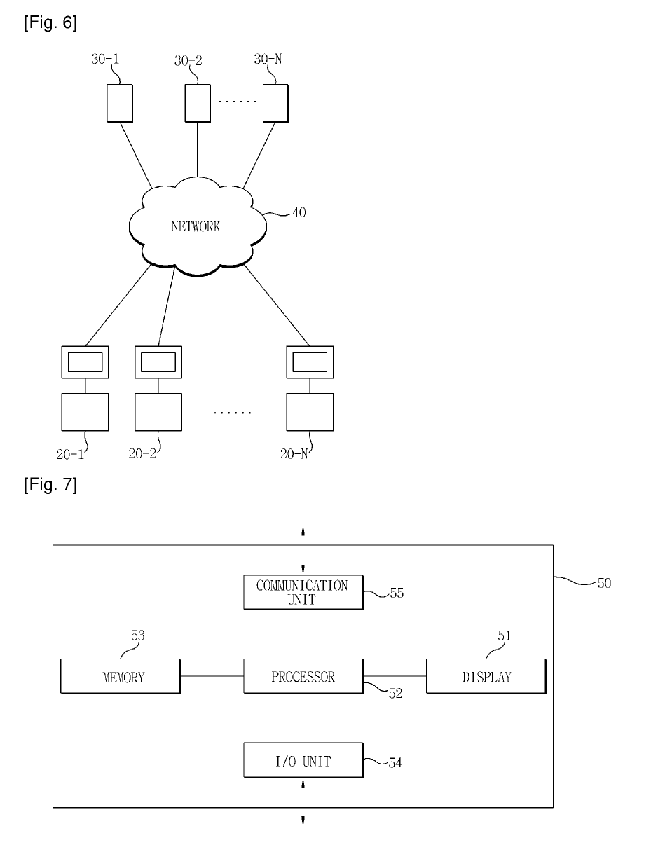

FIG. 6 shows an exemplary detailed structure of a website login processing system according to an embodiment of the present invention. Each of servers 30-1, 30-2, . . . and 30-n may correspond to the website system 30 according to this embodiment. Each of user computers 20-1, 20-2, . . . and 20-n may correspond to the user ID management system 20 according to this embodiment. The servers and the user computers are connected to each other through a network 40, such as the Internet.

FIG. 7 shows a structure of a system that can operate as servers and user computers according to an embodiment of the present invention. A system 50 includes a display 51, a processor 52, and a memory 53. The display 51 shows a user work processed by the system 50, if necessary. The processor 52 controls the whole operation of the system 50. The memory 53 stores data and various application programs needed when operating the system 50. The display 51, the processor 52, and the memory 53 may correspond to the information display unit 21, the information processing units 22 and 32, and the information storing units 23 and 33 according to this embodiment, respectively. The processor 52 may perform a function of the web page providing unit 31 by operating an application program having a function of providing a web page.

The system 50 may include an I/O unit 54 that processes the operation of a user on an input device, such as a keyboard and a mouse, and an output device, such as a printer and a speaker, and a communication unit 55 that enables a communication with an external network.

Although the exemplary embodiment described above is specified by the specific structure and the drawings, it should be understood that the present invention is not limited by the exemplary embodiment. Accordingly, it will be apparent to those skilled in the art that the present invention includes various modifications and equivalents thereof that do not depart from the scope and spirit of the present invention.

1. A website login processing method that performs a login process in a computer in which website information and one or more information needed when logging in a corresponding website are associated with each other and stored, the website login processing method comprising:
(a) a step of receiving a login command on a specific website from a user; and
(b) a step of, in response to the login command, performing a login process on the specific website on the basis of user information, which is selected by the user among a plurality of user information associated with the specific website and stored in the computer.

2. The website login processing method of claim 1, wherein the step (b) includes:
(b1) a step of displaying the plurality of user information associated with the specific website and stored in the computer; and
(b2) a step of performing a login process on the specific website on the basis of the user information selected by the user among the plurality of displayed user information.

3. The website login processing method of claim 1, wherein the step (b) is performing a login process on the specific website on the basis of user information selected by the user as a default in advance, among the plurality of user information associated with the specific website and stored in the computer.

4. The website login processing method of claim 1, wherein the computer further stores an encryption key for the user information that is generated using random numbers, and the step (b) includes validating the login using the encryption key.

5. The website login processing method of claim 1, further comprising:
(c) a step of providing a computer program, which allows the website login processing method to be executed, to the computer; and
(d) a step of, when the computer executes the computer program, communicating with the computer to execute the login process.

6. The website login processing method of claim 5, wherein the step (d) includes:
(d1) a step of receiving the user information, which is needed when logging in the specific website, from the computer and storing the user information;
(d2) a step of receiving a login request for the specific website from the computer; and
(d3) a step of comparing user information included in the received login request with the user information stored in the step (d1) to validate the login.

7. The website login processing method of claim 5, wherein the step (d) includes:
(d1) a step of receiving an encryption key, which is generated using random numbers with respect to the user information that is needed when logging in the specific website, from the computer and storing the user information;
(d2) a step of receiving a login request for the specific website from the computer; and
(d3) a step of comparing an encryption key included in the received login request with the encryption key stored in the step (d1) to validate the login.

8. An apparatus for processing a login for a specific website, the apparatus comprising:
an information storing unit for storing a plurality of user information in association with a single user;
a webpage providing unit for providing a webpage of the specific website to a user; and
an information processing unit for allowing the login when user information selected, among the plurality of user information, by the user and user information stored in the information storing unit are matched.

9. The apparatus of claim 8, wherein the information storing unit further stores an encryption key for the user information, and the information processing unit determines whether to allow the login based on the encryption key.

10. A method of processing a login for a specific website, the method comprising the steps of:
(a) storing a plurality of user information in association with a single user;
(b) providing a webpage of the specific website to a user; and
(c) allowing the login when user information selected, among the plurality of user information, by the user and user information stored in the information storing unit are matched.

11. The method of claim 10, wherein the step (a) includes further storing an encryption key for the user information, and the step (c) includes determining whether to allow the login based on the encryption key.
